(19) United States
(12) Patent Application Publication
(10) Pub. No.: US 2017/0193113 A1
(43) Pub. Date: Jul. 6, 2017

(54) Indexing Auxiliary Domains

(71) Applicants: Anthony Ko-Ping Chien, Foster City, CA (US); Kevin A. Li, New York, NY (US)

(72) Inventors: Anthony Ko-Ping Chien, Foster City, CA (US); Kevin A. Li, New York, NY (US)

(21) Appl. No.: 15/384,401

(22) Filed: Dec. 20, 2016

Related U.S. Application Data
(60) Provisional application No. 62/272,726, filed on Dec. 30, 2015.

(51) Int. Cl. G06F 17/30

(52) U.S. Cl. CPC G06F 17/30864; G06F 17/30887

(57) ABSTRACT

Methods, systems, and products determine intradomain and interdomain search results. When a website query is received, the website query specifies a domain and a search term. The intradomain search results are generated by searching the domain for the search term. The interdomain search results, though, are generated by searching auxiliary domains for the search term.

### CROSS-REFERENCE TO RELATED APPLICATION

This application claims the benefit of U.S. Provisional Application 62/272,726 filed Dec. 30, 2015, which is incorporated herein by reference in its entirety.

### BACKGROUND

Conventional e-commerce websites ignore outside content. Product webpages conventionally offer an explanation of a particular product, perhaps even including detailed specifications. Yet the Internet in general may include even more useful information.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIG. 1 is a simplified schematic illustrating an environment in which exemplary embodiments may be implemented;

FIGS. 2-4 are more detailed schematics illustrating the operating environment, according to exemplary embodiments; and

FIG. 5 illustrates a product similarity function, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

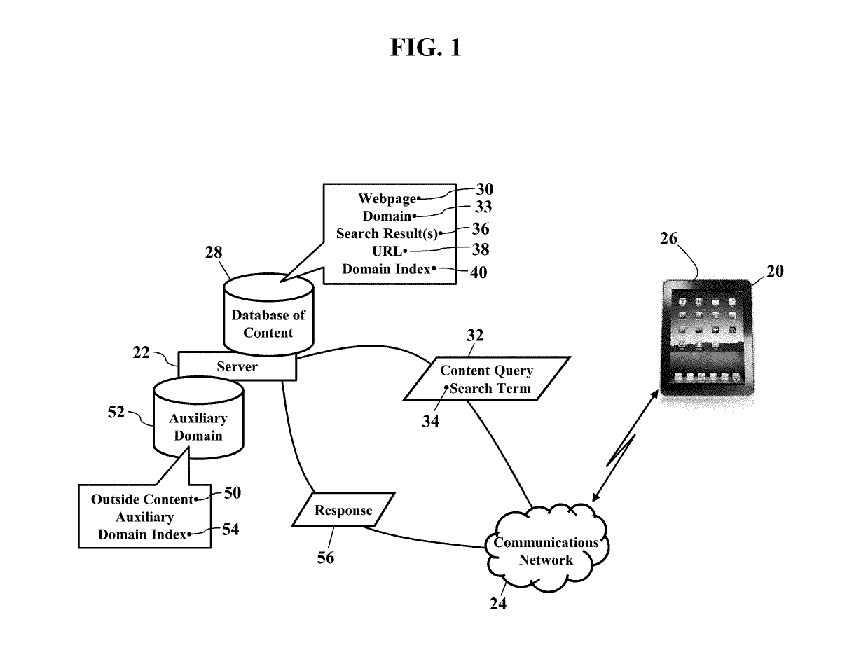

FIG. 1 is a schematic illustrating an environment in which exemplary embodiments may be implemented. FIG. 1 illustrates a client device 20 that communicates with a server 22 via a communications network 24. The client device 20, for simplicity and familiarity, is illustrated as a mobile tablet computer 26. The client device 20, however, may be any other mobile or stationary device, as later paragraphs will explain. Regardless, the server 22 may store one or more databases 28 of content. When a user of the tablet computer 26 wishes to retrieve some information (such as a webpage 30), the user's tablet computer 26 submits a content query 32 to the server 22. The content query 32 requests a search of a web site domain 33 and includes or specifies a search term 34. When the server 22 receives the content query 32, the server 22 queries the database 28 of content for the search term 34 and retrieves one or more search results 36. The search results 36 may include various website links (such as uniform resource locators or “URLs” 38) that are indexed or associated with the website domain 33 and with search term 34. The database 28 of content thus consults an electronic domain index 40 that electronically associates the search term 34 to electronic content found in or at the website domain 33.

Here, though, exemplary embodiments may include outside content 50. That is, the server 22 may retrieve additional or auxiliary content that is outside the electronic domain index 40. The server 22, for example, may query one or more auxiliary domains 52 for the search term 34 and thus retrieve the outside content 50 that is also indexed to the search term 34. The server 22, in other words, may additionally query one or more auxiliary domain indexes 54 for the same search term 34. When the server 22 sends a response 56 to the query 32, the server 22 may thus include both the search results 36 (determined from the domain index 40) and the outside content 50 (determined from the auxiliary domain index 54). Exemplary embodiments thus boost the search results by retrieving the outside content 50 that is beyond the limited corpus associated with the database 28 of content (e.g., the electronic domain index 40).

An example helps illustrates the outside content 50. Suppose the user searches the domain www.newegg.com for a video card to play an electronic game called “Counterstrike.” If the user queries for the search term “counterstrike,” however, no search results will be found. The electronic domain index 40 that corresponds with the domain www.newegg.com lacks an entry. The search term “counterstrike” is thus not indexed or associated with the www.newegg.com domain. In simple words, the search term “counterstrike” does not appear in any of the product listings associated with the www.newegg.com domain. Yet if the user searches a different domain (such as www.google.com or any other general purpose web search engine), she will discover several forums where the “best video cards for counterstrike” are discussed and recommended. So, even though Newegg's domain contained no product page indexed to “counterstrike,” the larger Internet contains a wealth of information that indexes to “counterstrike.” Exemplary embodiments may thus add the outside content 50 (retrieved from the auxiliary domain 52 www.google.com) to Newegg's electronic domain index 40 to reveal or surface results that otherwise would not be found. Newegg may now recommend a video card (perhaps via a recommendation/similarity engine) for an eventual sale, despite having no product page in its electronic domain index 40.

Boosted search results may thus improve e-commerce sales. Conventional e-commerce websites only index their respective domains. These e-commerce websites, though, may increase their product offerings and potential sales by indexing both their domain plus the outside auxiliary domain(s) 52. Exemplary embodiments thus add informational materials to the electronic domain index 40 from outside the result set. Exemplary embodiments may automatically power additional searches using words from other users and/or other websites. There are many interdomains (e.g., outside the www.newegg.com domain) that may yield valuable and/or pertinent product information. Forums, user-generated commentary, recommendations, and other social websites are just some examples of interdomains that may be indexed to product listings. These knowledge repositories are ordinarily ignored. Exemplary embodiments, though, may index these knowledge repositories to different subject matter, thus providing the outside content 50 to augment a product listing.

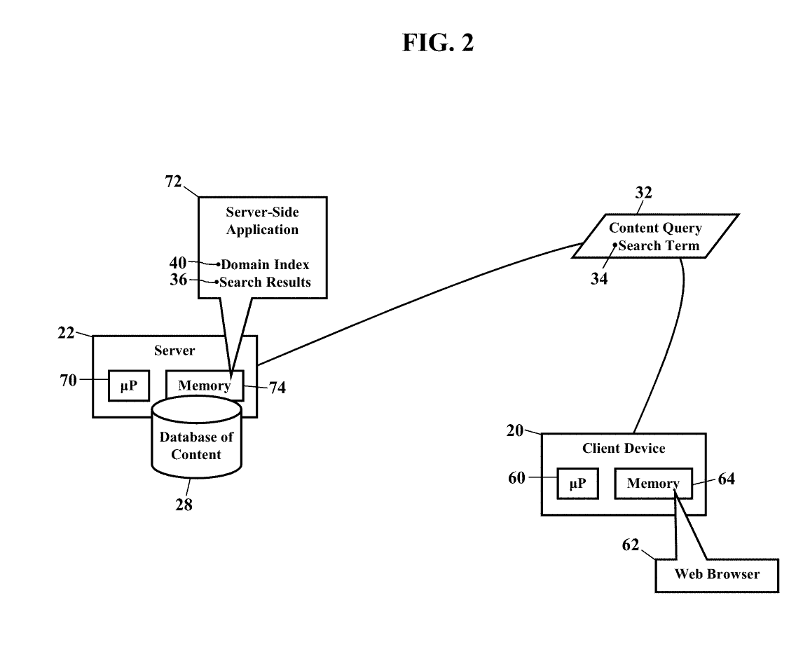

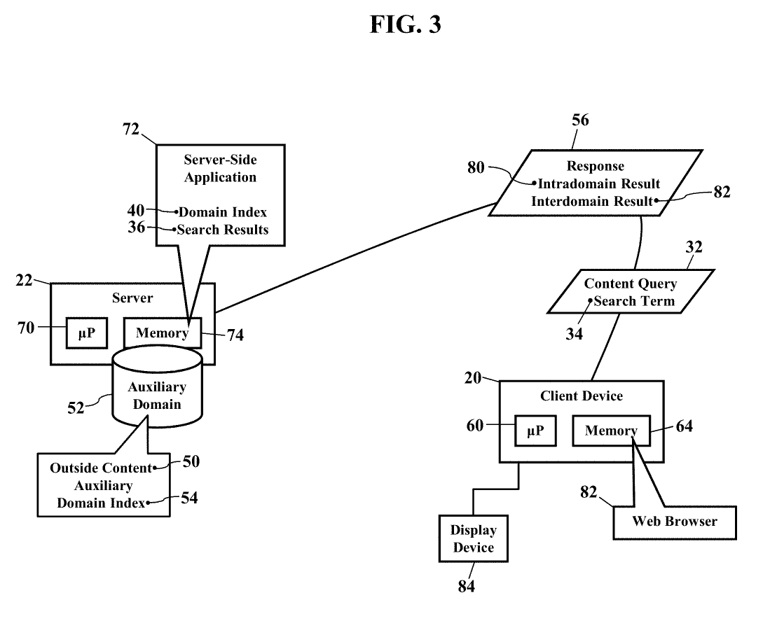

FIGS. 2-3 are more detailed schematics illustrating the operating environment, according to exemplary embodiments. Here the client device 20 is generically illustrated as any system or device having a processor 60 (e.g., “μP”), application specific integrated circuit (ASIC), or other component that executes a web browser 62 stored in a local memory 64. The server 22 may also have a processor 70 (e.g., “μP”), application specific integrated circuit (ASIC), or other component that executes a server-side application 72 stored in a local memory 74. The web browser 62 and/or the server-side application 72 include algorithms, instructions, code, and/or programs that perform operations, such as retrieving the search results 36 associated with the search term 34. The client device 20 generates and sends the content query 32 including information representing the search term 34. The server 22 queries the domain index 40 for the search term 34 and retrieves the search results 36.

FIG. 3 illustrates the outside content 50. The server-side application 72 instructs the server 22 to also query the one or more outside auxiliary domains 52 for the same or related search term 34. The server 22 retrieves the outside content 50 that is also indexed to the search term 34. The server 22 may thus generate the response 56 to the query 32 that includes both an intradomain result 80 and an interdomain result 82. The server 22, in other words, may query the electronic domain index 40 and retrieve the intradomain result 80 that is associated with the search term 34. However, the server 22 may also query the outside auxiliary domain(s) 52 and retrieve the interdomain result 82 that is also associated with the search term 34. The server 22 may then combine the intradomain result 80 and the interdomain result 82 as the resultant response 56. The server-side application 72 instructs the server 22 to send the response 56 to the network address associated with the client device 20. The client device 20 thus processes the search response 56 for display on its display device 84.

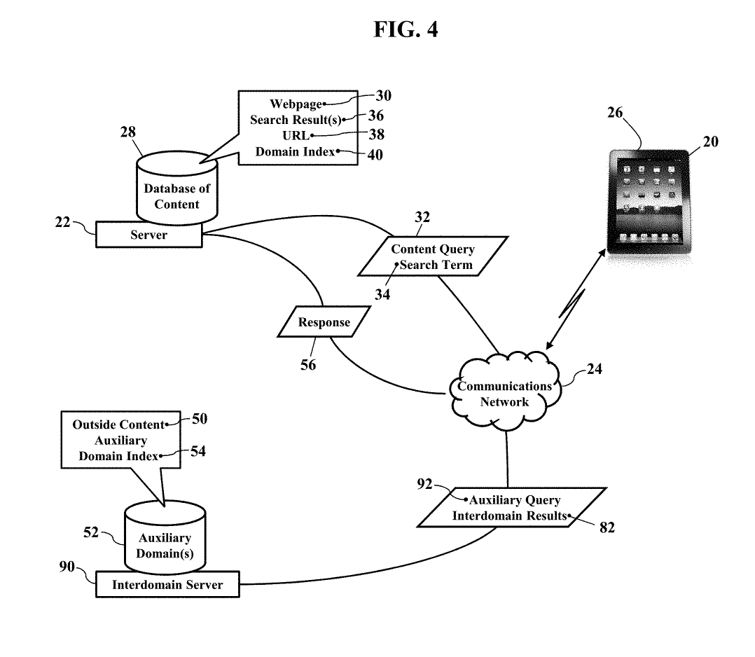

FIG. 4 is another detailed schematic illustrating the operating environment, according to exemplary embodiments. Here exemplary embodiments may include a third party interdomain server 90 that stores or maintains the auxiliary domain index(es) 54. The interdomain server 90 may thus maintain subject matter and/or key word associations for one or many outside auxiliary domains 52. The interdomain server 90, for example, may crawl and index any domain name and/or URL and make the resultant auxiliary domain index 54 available as a third party service. When the server 22 receives the content search query 32 sent from the client device 20, the server-side application 72 may instruct the server 22 to generate an auxiliary query request 92. The auxiliary query request 92 may include any information or data related to the search term 34 specified in the content search query 32 sent from the client device 20. The server-side application 72 may instruct the server 22 to send the auxiliary query request 92 to a network address associated with the interdomain server 90. The interdomain server 90 queries its auxiliary domain index(es) 54 for the search term 34 and retrieves the interdomain result 82 that is electronically associated to the search term 34 specified in the auxiliary query request 92. The interdomain server 90 sends the interdomain result 82 to the network address associated with the server 22 and/or to the client device 20. The server 22, for example, may combine the intradomain result 80 and the interdomain result 82 and send the resultant response 56 to the requesting client device 20. The interdomain server 90 may thus provide the interdomain result 82 as a third party search service to augment website searches with the outside content 50.

Exemplary embodiments may provide a third party similarity function. The reader may be familiar with a “more like this” feature provided by some websites. Suppose, for example, the user wishes to search for a restaurant that is similar to a particular one she likes. The user may thus enter the restaurant's name as the search term 34. As the reader may understand, though, “similarity” can be very nuanced and include various intangible properties. A restaurant's “ambiance,” for example, may be difficult to textually describe. Exemplary embodiments, though, may index various website domains to which users post commentary content (e.g., such YELP® reviews, INSTAGRAM® posts, and/or FACEBOOK® posts). Exemplary embodiments may compare the types of language used to describe a particular restaurant to other restaurants. Other restaurants that are described using the same types of words and language may then be labeled and indexed as similar. Indeed, this approach may be used to leverage the massive amount of content being generated by social media websites to power “more like this” functionality for any domain. The interdomain server 90 may thus index user-generated commentary as the interdomain result 82 for a third party service.

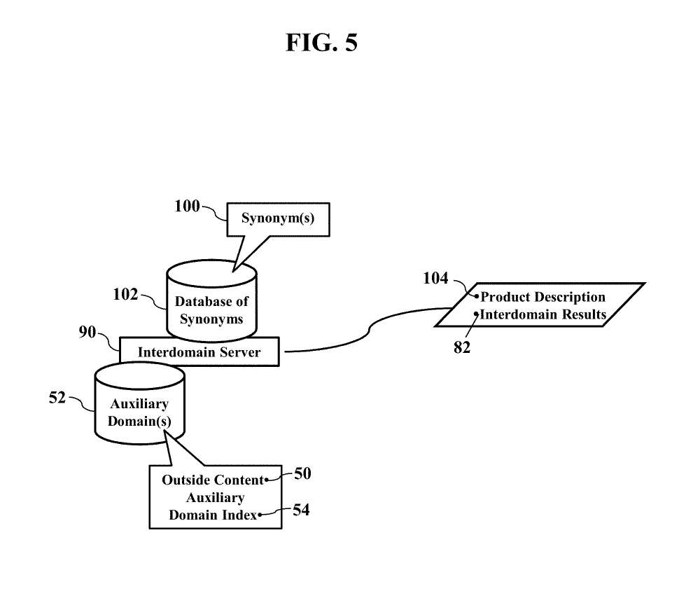

FIG. 5 illustrates a product similarity function, according to exemplary embodiments. One functionality that many different types of websites desire is the ability to show the user a number of alternative products that are similar to a currently viewed product. This collaborative filtering usually requires a large amount of data. However, many websites lack this comprehensive usage data. Exemplary embodiments may thus be applied to generate data from outside sources to boost the index. Exemplary embodiments may thus provide this product similarity function as a third party service using content generated on the web as a form of synthetic data. For example, if a user is looking at a particular video card on a website, exemplary embodiments may identify other video cards that are similar based on similar wording on popular hardware forums (such as www.tomshardware.com or www.anandtech.com). That is, synonyms 100 in wording may reveal similar products. Exemplary embodiments may thus search for the outside content 50 that is related to one or more synonyms 100 to the user's search term 34. Exemplary embodiments, for example, may query a database 102 of synonyms for the search term 34 and then execute searches of the auxiliary domain index 54 for the synonyms 100. As an example, exemplary embodiments may additionally or alternatively search for the outside content 50 that is related to the synonyms 100 in a product description 104. Exemplary embodiments thus boost search results beyond the typical product detail comparison that relies on specifications alone. Social commenting may thus be used to drive product similarity in a better way than simply identifying other products other users have looked at.

Exemplary embodiments may be applied to any item or content discovery. Indeed, exemplary embodiments may locate products a particular host website may not even offer. Assume the user is looking for a particular video card called an “NVidia GTX970.” Even if the website domain does not offer or inventory that product, exemplary embodiments may be used to reveal a similar product offering called “NVidia GTX 780,” which may be returned and displayed for a possible sale.

Exemplary embodiments may also utilize collaborative editing of results. That is, collaborative filtering may be used to further augment the interdomain search results 82. A number of websites (such as www.Reddit.com and www.producthunt.com) use upvoting/downvoting so the masses may comment on whether a particular webpage/product is interesting or useful. However, these sites typically require that the user generate the actual commentary content (i.e., write a post) before the upvoting/downvoting may be applied. Here, though, exemplary embodiments may auto-generate the interdomain search results 82 on demand. Moreover, as the interdomain search results 82 may include user-editable pages (considering a different user has likely previously performed the nearly exact same search), exemplary embodiments may incorporate thus user knowledge. Exemplary embodiments, in other words, may learn from other users' experiences. Exemplary embodiments thus allow users to upvote/downvote particular results on the webpage and/or add their notes as commentary. Exemplary embodiments may thus index this user commentary for retrieval as the interdomain search results 82. Then, the next time someone performs the exact same search, they will see the upvotes/downvotes from past users as well as their annotated notes. This will allow users to gauge the quality of the information on a web site before actually visiting/downloading.

Exemplary embodiments may be applied to travel queries. Suppose the user queries the website domain 33 for a travel destination. Exemplary embodiments may be used to retrieve the interdomain search results 82 for one or more similar destinations. The interdomain search results 82 may be generated based on similarities/synonyms of the descriptors that have been used to describe each destination from sources such as content publishing sites and user generated content (social media, forums, and other auxiliary domains 52). For example, if the user had a great time on a previous visit to Seville, Spain, exemplary embodiments may find other places that are similar in terms of culture, architecture, cost, cuisine, friendliness, and other descriptors.

Exemplary embodiments may be applied to food/restaurant queries. Suppose the user queries the website domain 33 for a name or address associated with a restaurant. Exemplary embodiments may be used to retrieve the interdomain search results 82 for other restaurants that are similar. The interdomain search results 82 may be generated based on similarities/synonyms of the descriptors that have been used to describe each restaurant or bar from sources such as content publishing sites and user generated content (social media, forums, and other auxiliary domains 52). For example, if the user like a specific restaurant but wants to try something new, exemplary embodiments find other restaurants that are similar in terms of cuisine, ambiance, vibe, clientele, price, location, and/or any other descriptive terms.

Exemplary embodiments may be applied to music queries. Suppose the user queries the website domain 33 for a name or title associated with a musical artist or group. Exemplary embodiments may be used to retrieve the interdomain search results 82 for other names or titles that are similar and/or synonymous. The interdomain search results 82 may be generated based on similarities of the descriptors that have been used to describe the musical artist or group. The interdomain search results 82 may be retrieved from sources such as content publishing sites and user generated content (social media, forums, and other auxiliary domains 52). For example, if the user really likes a certain band, exemplary embodiments find other bands that are similar in terms of music genre, fan type, theme, musical mood, lyrical focal point, and any other descriptor.

Exemplary embodiments may be applied to art queries. Suppose the user queries the website domain 33 for an artist name, title, and or descriptor associated with a painting, sculpture, or any other artistic effort. Exemplary embodiments may be used to retrieve the interdomain search results 82 for other names or titles having a similar or synonymous descriptor. For example, if the user queries for a painting, exemplary embodiments find other art works that are similar/synonymous in terms of artist, mood, time period, style, sentiment, and any other descriptor.

Exemplary embodiments may be applied to movies. Suppose the user queries the website domain 33 for a name or title associated with a movie or video. Exemplary embodiments may be used to retrieve the interdomain search results 82 for other names or titles that are similar to and/or synonymous with the query term and/or the descriptors. The interdomain search results 82 may be retrieved from sources such as content publishing sites and user generated content (social media, forums, and other auxiliary domains 52). For example, if the user really likes a movie title or actor, exemplary embodiments find other movies having a similar or synonymous genre, mood, cast, characters, plot, reputation/ratings, and any other descriptor.

Exemplary embodiments may be applied to real estate or housing queries. Suppose the user queries the website domain 33 for an address, neighborhood, community name, or builder name associated with a property. Exemplary embodiments may be used to retrieve the interdomain search results 82 for other properties having similar and/or synonymous descriptors. For example, if the user queries for an apartment or house, exemplary embodiments find other properties that are available for purchase or rent, even perhaps in terms of neighborhood vibe, safety, school systems, weather, price, and any other descriptor.

Exemplary embodiments may be applied to dating or matchmaking applications. Many dating websites allowing browsing of different candidates and viewing profile information. Exemplary embodiments would thus permit the user to query the website domain 33 for personality traits, activities, and other profile descriptors and retrieve the interdomain search results 82 for other candidates having similar and/or synonymous descriptors. For example, if the user likes the profile of a certain person, she may use the exemplary embodiments as a tool to find other potential dates having similar and/or synonymous education, personality, philosophy in dating, stage in life, and any other descriptor. Additionally, exemplary embodiments may even train a classifier using the descriptors to predict whether or not the user would like a certain candidate.

Exemplary embodiments may be applied to video content queries. Suppose the user queries the website domain 33 for a name or title associated with a movie or video. Exemplary embodiments may be used to retrieve the interdomain search results 82 for other names or titles that are similar to and/or synonymous with the query term and/or the descriptors. Exemplary embodiments may even leverage computer vision to tease out additional attributes to query. For example, if the user finds a specific video entertaining, she may use exemplary embodiments to find other online or offline videos that are similar in terms of type (e.g., webisodes, amateur, advertisement, movie), genre (e.g., thriller, drama, science fiction), emotions evoked (e.g., happy, sad, funny), cast, setting, duration, sentiment, and any other descriptor.

Exemplary embodiments may be applied to recipe queries. Suppose the user queries the website domain 33 for a name or ingredient associated with a dish or recipe. Exemplary embodiments may be used to retrieve the interdomain search results 82 for other recipes or dish names that are similar to and/or synonymous with the query term and/or the descriptors. For example, if the user queries for a lasagna recipe, exemplary embodiments may retrieve other recipes that are similar and/or synonymous in terms of an effort or amount of work, serving size, ingredients, flavors, type of cuisine, and any other descriptor.

Exemplary embodiments may be applied to business intelligence. Suppose the user queries the website domain 33 for a corporate name, component name, or employee name associated with a company. Exemplary embodiments may be used to retrieve the interdomain search results 82 for other content having a similar and/or synonymous descriptor from sources such as a company website, content publishing sites, and user generated content (social media, forums, and other auxiliary domains 52). For example, if the user queries for a software security company, exemplary embodiments may retrieve names or employees of other companies having a similar and/or synonymous customers, industry, services, products, size, reputation, and any other descriptor.

Exemplary embodiments may be applied to data prospecting. Suppose again that the user queries the website domain 33 for a corporate name, component name, or employee name associated with a company. Exemplary embodiments may find company requirements and a point of contact, thus revealing sales opportunities. For example, if the user owns a web analytics company, exemplary embodiments may return a list of companies that are candidates for product sales, as well as the appropriate contacts within the company that make purchasing decisions. Exemplary embodiments may thus help the user or her company manage its sales process. Exemplary embodiments may even train a classifier by using the descriptors of the targeted companies. The descriptors may be sourced from places such as the company website, content publishing sites, and user generated content.

Exemplary embodiments may be applied to human resources. For example, exemplary embodiments may identify recruits and other “candidates like this one” queries. Suppose the user queries the website domain 33 for a job description. Exemplary embodiments may thus generate a list of people that would be great candidates to contact for the position. For example, suppose the user queries for a job description for a lead web developer. Exemplary embodiments return a list of candidates based on attributes such as experience in relevant areas, skill sets, education, peer reviews, personality, interests, location, and any other descriptor. This third party service would be part of a platform to help companies manage their hiring process. Exemplary embodiments accept the job description and perhaps even augment the job description with outside data. Exemplary embodiments hone on the descriptors of each of the candidates and their result in the hiring process.

Exemplary embodiments may be applied to commercial real estate. Suppose the user queries the website domain 33 for an address, tenant, name, or management associated with a property. Exemplary embodiments may be used to retrieve the interdomain search results 82 for other properties having similar and/or synonymous descriptors. For example, if the user queries for a property listing, exemplary embodiments find other properties that are available for purchase or rent, even perhaps in terms of rental or purchase cost, size, location, area, proximity to mass transportation, lunch options, peer demographics, and any other descriptor.

Exemplary embodiments may be applied to pets. Suppose the user queries the website domain 33 for name, breed, or trait associated with an animal or pet. Exemplary embodiments may be used to retrieve the interdomain search results 82 for other animals or pets having similar and/or synonymous descriptors. For example, if the user queries for a certain breed of dog, exemplary embodiments find listings and breeders having similar and/or synonymous size, health concerns, shedding, aggressiveness, trainability, personality, and any other descriptor.

Exemplary embodiments may be applied to health care. Suppose the user queries the website domain 33 for a symptom or medication. Exemplary embodiments may be used to retrieve the interdomain search results 82 for other health issues, medications, or symptoms having similar and/or synonymous descriptors. For example, if the user queries for a disease symptom, exemplary embodiments generate a list of possible conditions that could cause the disease symptom. The results may be generated based on similarities or synonyms of the descriptors that have been used to describe the symptoms from sources such as content publishing sites and user generated content (social media, forums, and other auxiliary domains 52). For example, if the user wakes up with a sore throat and swollen lymph nodes, she may query and retrieve a possible diagnosis based on the responses of other instances where people have entered the same symptoms. Similarly, exemplary embodiments may return other patients having the same or synonymous conditions and backgrounds in the hopes that it can help treat the queried patient more effectively. The results may be generated based on similarities of the descriptors of each patient based on their full medical records. For example, if a patient expresses or enters a set of symptoms, the doctor may use exemplary embodiments to find other patients that not only have similar symptoms, but may also be similar in terms of medical history, diet, location, allergies, ethnicity, age, personality, and other descriptors. The doctor may thus then see what treatments worked or did not work for those comparable patients.

Exemplary embodiments may be applied to financial services. For a given financial instrument, exemplary embodiments may return other ones that are similar or synonymous. The results may be generated based on similarities of the descriptors that have been used to describe each one from sources such as financial data, content publishing sites and user generated content. For example, if the user queries for company name or stock symbol, exemplary embodiments may find other equity stocks that have similar historical financial performance, sectors, consumer sentiment, investors, liquidity, and other descriptors.

Exemplary embodiments may be applied to news services. As this disclosure above explained, exemplary embodiments provide a third party service for generating a “show me more like this one” functionality. In other words, for a given news article, exemplary embodiments may return other news articles having some similar or synonymous descriptor. The results may be generated based on synonyms of the descriptors that have been used to describe each one from sources such as content publishing sites and user generated content (social media, forums, and other auxiliary domains 52). For example, if the user enjoyed a certain article, exemplary embodiments may find other articles that are similar in terms of topic, source, consumer sentiment, audience, and other descriptors.

Exemplary embodiments may be applied to event planning. For a given entertainment event, exemplary embodiments may return other ones that are similar. The results may be generated based on similarities of the descriptors that have been used to describe each one from sources such as content publishing sites and user generated content (social media, forums, and other auxiliary domains 52). For example, if the user liked a recent outdoor concert, exemplary embodiments find other local events that are similar in terms of type (sports, music, etc), audience, overall sentiment, price, atmosphere, and other descriptors.

Exemplary embodiments may be physically embodied on or in a processor-readable device or storage medium. For example, exemplary embodiments may include CD-ROM, DVD, tape, cassette, floppy disk, optical disk, memory card, memory drive, and large-capacity disks.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A method, comprising:
receiving, by a server, an electronic query sent from a client device, the electronic query specifying a website domain and a search term;
querying, by the server, an electronic domain index for the search term, the electronic domain index electronically associating the website domain to subject matter;
identifying, by the server, intradomain search results in the electronic domain index that are electronically associated with the search term specified by the electronic query sent from the client device;
querying, by the server, an electronic auxiliary domain index for the search term, the electronic auxiliary domain index associated with an auxiliary domain outside the website domain, the electronic auxiliary domain index electronically associating the auxiliary domain to the subject matter;
identifying, by the server, interdomain search results in the electronic auxiliary domain index that are electronically associated with the search term specified by the electronic query sent from the client device; and
generating, by the server, a response to the electronic query, the response comprising both the intradomain search results and the interdomain search results.

2. The method of claim 1, further comprising sending the interdomain search results to the client device.

3. The method of claim 1, further comprising sending the intradomain search results to the client device.

4. The method of claim 1, further comprising retrieving the interdomain search results.

5. The method of claim 1, further comprising retrieving the intradomain search results.

6. The method of claim 1, further comprising combining the interdomain search results and the intradomain search results.

7. The method of claim 1, further comprising determining a uniform resource locator associated with at least one of the interdomain search results and the intradomain search results.

8. A system, comprising:
a hardware processor; and
a memory device, the memory device storing code, the code when executed causing the hardware processor to perform operations, the operations comprising:
receiving an electronic query sent from a client device, the electronic query specifying a website domain and a search term;
querying an electronic domain index for the search term, the electronic domain index electronically associating the website domain to subject matter;
identifying intradomain search results in the electronic domain index that are electronically associated with the search term specified by the electronic query sent from the client device;
querying an electronic auxiliary domain index for the search term, the electronic auxiliary domain index associated with an auxiliary domain outside the website domain, the electronic auxiliary domain index electronically associating the auxiliary domain to the subject matter;
identifying interdomain search results in the electronic auxiliary domain index that are electronically associated with the search term specified by the electronic query sent from the client device; and
generating a response to the electronic query, the response comprising both the intradomain search results and the interdomain search results.

9. The system of claim 8, wherein the operations further comprise sending the interdomain search results to the client device.

10. The system of claim 8, wherein the operations further comprise sending the intradomain search results to the client device.

11. The system of claim 8, wherein the operations further comprise retrieving the interdomain search results.

12. The system of claim 8, wherein the operations further comprise retrieving the intradomain search results.

13. The system of claim 8, wherein the operations further comprise combining the interdomain search results and the intradomain search results.

14. The system of claim 8, wherein the operations further comprise determining a uniform resource locator associated with at least one of the interdomain search results and the intradomain search results.

15. A memory device storing instructions that when executed cause a hardware processor to perform operations, the operations comprising:
receiving an electronic query sent from a client device, the electronic query specifying a website domain and a search term;
querying an electronic domain index for the search term, the electronic domain index electronically associating the website domain to subject matter;
identifying intradomain search results in the electronic domain index that are electronically associated with the search term specified by the electronic query sent from the client device;
querying an electronic auxiliary domain index for the search term, the electronic auxiliary domain index associated with an auxiliary domain outside the website domain, the electronic auxiliary domain index electronically associating the auxiliary domain to the subject matter;
identifying interdomain search results in the electronic auxiliary domain index that are electronically associated with the search term specified by the electronic query sent from the client device; and
generating a response to the electronic query, the response comprising both the intradomain search results and the interdomain search results.

16. The memory device of claim 15, wherein the operations further comprise sending the interdomain search results to the client device.

17. The memory device of claim 15, wherein the operations further comprise sending the intradomain search results to the client device.

18. The memory device of claim 15, wherein the operations further comprise retrieving the interdomain search results.

19. The memory device of claim 15, wherein the operations further comprise retrieving the intradomain search results.

20. The memory device of claim 15, wherein the operations further comprise combining the interdomain search results and the intradomain search results.
